(19) United States
(12) Patent Application Publication
(10) Pub. No.: US 2006/0027033 A1
(43) Pub. Date: Feb. 9, 2006

(54) Hand-held pipette employing voice recognition control

(76) Inventors: Richard Cote, Bolton, MA (US); Robert Henry Zier, Annapolis, MD (US); Craig Weiss, Sudbury, MA (US); William Frazier, Andover, MA (US)

Correspondence Address: GAUTHIER & CONNORS, LLP, 225 FRANKLIN STREET, BOSTON, MA, 02110, US

(21) Appl. No.: 10/903,448

(22) Filed: Jul. 30, 2004

Related U.S. Application Data
(63) Continuation-in-part of application No. 10/271,867, filed on Oct. 16, 2002, now Pat. No. 6,923,938.
(63) Continuation-in-part of application No. 10/855,690, filed on May 27, 2004.
(60) Provisional application No. 60/491,107, filed on Jul. 30, 2003.

(51) Int. Cl. B01L 3/02

(52) U.S. Cl. 73/864.02

(57) ABSTRACT

A hand-held pipette is disclosed including a pipette tip, a piston, and a voice recognition and control system. The pipette tip is provided at one end of an elongated enclosure. The piston is received in an opposite end of the elongated enclosure. The piston is adapted for reciprocal movement within at least a portion of the elongated enclosure through a selected first stroke to aspirate a first volume of fluid into the pipette tip and to expel the thus aspirated first volume of fluid out of the pipette tip. The voice recognition and control system is for automatically adjusting the stroke of the piston from the first stroke to a second stroke responsive to voice commands such that a second volume of fluid may be aspirated into the pipette tip and the thus aspirated second volume of fluid may be expelled out of the pipette tip.

### CROSS REFERENCE TO RELATED APPLICATIONS

This application claims priority to U.S. Provisional Patent Application Ser. No. 60/491,107 filed Jul. 30, 2003, and claims priority to U.S. patent application Ser. No. 10/271,867 filed Oct. 16, 2002, which claims priority to U.S. Provisional Patent Applications Ser. Nos. 60/329,704 and 60/329,706, each filed on Oct. 16, 2001, and further claims priority to U.S. patent application Ser. No. 10/855,690 filed May 27, 2004.

### FIELD OF THE INVENTION

The present invention relates generally to transferring and dispensing devices for liquid reagents and samples, and more particularly to hand-held pipettes.

### BACKGROUND OF THE INVENTION

Pipetting systems are widely utilized in laboratories and hospitals for withdrawing and dispensing relatively small, predetermined quantities of liquids from one location to another, such as between test tubes, microplates and other liquid receptacles. Portable, or hand-held, pipettes are one type of pipetting system. Hand-held pipettes generally include a housing, a cylinder including two cylinder ends, with one end positioned within the housing and the other end extending from the housing to form a pipette tip holder, a piston that moves within the cylinder to withdraw liquid from a supply receptacle and dispense the liquid to a receiving receptacle, and a plunger that drives the piston. While not a permanent part of the pipettor, a disposable pipette tip is commonly attached to the end of the tip holder to retain the liquid to be transferred. This tip can be removed from the tip holder, disposed of, and replaced with a new tip. These hand-held pipettes may be configured to transfer liquids by automated or manual actuation of the pipette. Automatically operated hand-held pipettors generally include a motor for actuating the plunger to move the piston within the pipette cylinder for liquid transfer. Manually operated hand-held pipettes require the pipette user to apply force to the plunger head, usually with a thumb or a finger, to actuate the piston.

Hand-held pipettes may be designed as fixed volume pipettes, where only one predetermined liquid volume is withdrawn and dispensed, or as adjustable pipettes, where the user may set a desired volume to be dispensed within a given volume range. Stop features located within a pipette determine the distance that a piston will travel, also known as the stroke. The stroke corresponds to the volume of liquid to be withdrawn and dispensed. Hand-held pipettes commonly include two stops to establish the limits of the stroke. For purposes of the foregoing description, these two stops will be referred to as a front stop and a rear stop. In this description, the front stop is the stop closest to the tip holder and the rear stop is the stop closest to the plunger head, or in a manual pipette, the end of the plunger that is manually actuated by a pipette user. The stops in a fixed volume pipette are fixed, and the piston travels the same stroke during each complete actuation of the plunger. In an adjustable volume pipette, at least one of the stops is movable to adjust the stroke length of the piston, and thus the volume to be withdrawn and dispensed.

In manual pipette applications where the volume of liquid to be transferred may vary frequently within a single application, the pipette user must frequently change the volume settings on the pipette, which can cause fatigue and potentially inaccurate volume settings on the pipette.

There is a need, therefore, for a pipette that is efficient, accurate and easy to use.

### SUMMARY

In accordance with an embodiment, the invention provides a hand-held pipette including a pipette tip, a piston, and a voice recognition and control system. The pipette tip is provided at one end of an elongated enclosure. The piston is received in an opposite end of the elongated enclosure. The piston is adapted for reciprocal movement within at least a portion of the elongated enclosure through a selected first stroke to aspirate a first volume of fluid into the pipette tip and to expel the thus aspirated first volume of fluid out of the pipette tip. The voice recognition and control system is for automatically adjusting the stroke of the piston from the first stroke to a second stroke responsive to voice commands such that a second volume of fluid may be aspirated into the pipette tip and the thus aspirated second volume of fluid may be expelled out of the pipette tip.

In accordance with another embodiment, the invention provides a hand-held pipette system including a pipette tip, a piston, a voice recognition unit, and a control unit. The pipette tip is provided at one end of an elongated enclosure. The piston received in an opposite end of the elongated enclosure. The piston is adapted for reciprocal movement within at least a portion of the elongated enclosure through a selected first stroke to aspirate a first volume of fluid into the pipette tip and to expel the thus aspirated first volume of fluid out of the pipette tip. The voice recognition actuation switch may be actuated by a user. The voice recognition unit is for providing a control signal responsive to a voice input signal received while the voice actuation switch is activated. The control unit is for automatically adjusting the stroke of the piston from the first stroke to a second stroke responsive to control signal such that a second volume of fluid may be aspirated into the pipette tip and the thus aspirated second volume of fluid may be expelled out of said pipette tip.

In accordance with another embodiment, a hand-held pipette includes a pipette tip, a piston, a voice recognition unit, and a control unit. The pipette tip is provided at one end of an elongated enclosure. The piston is received in an opposite end of the elongated enclosure. The piston is adapted for reciprocal movement within at least a portion of the elongated enclosure through a selected first stroke to aspirate a first volume of fluid into the pipette tip and to expel the thus aspirated first volume of fluid out of the pipette tip. The voice recognition unit is for providing a control signal responsive to a voice input signal. The voice recognition unit includes a predictive unit for matching a partial input string of numbers against a pre-defined group of possible settings, and for automatically entering the remaining numbers when only one possible setting exists for the partial input string. The control unit is for automatically adjusting the stroke of the piston from the first stroke to a second stroke responsive to control signal such that a second volume of fluid may be aspirated into the pipette tip and the thus aspirated second volume of fluid may be expelled out of the pipette tip.

In further embodiments, the pipette may be fully automatic and may include an actuation unit for automatically moving the piston within at least a portion of the elongated enclosure through the selected stroke to aspirate a first volume of fluid into the pipette tip responsive to an actuation signal, and/or to dispense the first volume of fluid from the pipette tip response to the actuation signal.

### BRIEF DESCRIPTION OF THE DRAWINGS

The following description may be further understood with reference to the accompanying drawings in which:

FIG. 1 is a vertical sectional view taken through a manual hand-held pipette in accordance with an embodiment of the invention;

FIG. 2 is a horizontal sectional view on an enlarged scale taken along line 4-4 of FIG. 1;

FIG. 3 is an enlarged view of a portion of FIG. 1;

FIG. 4 is a schematic diagram of the voice recognition system;

FIG. 5 is an isometric view of a manual hand-held pipette in accordance with an embodiment of the invention;

FIG. 6 is a side view of the manual hand-held pipette shown in FIG. 5; and

FIG. 7 is a functional block diagram of the operation of a hand-held pipette in accordance with an embodiment of the invention;

FIG. 8 is a vertical sectional view taken through a portion of an automatic hand-held pipette in accordance with another embodiment of the invention; and

FIG. 9 is a vertical sectional view taken through a manual hand-held pipette in accordance with a further embodiment of the invention.

### DETAILED DESCRIPTION OF THE ILLUSTRATED EMBODIMENTS

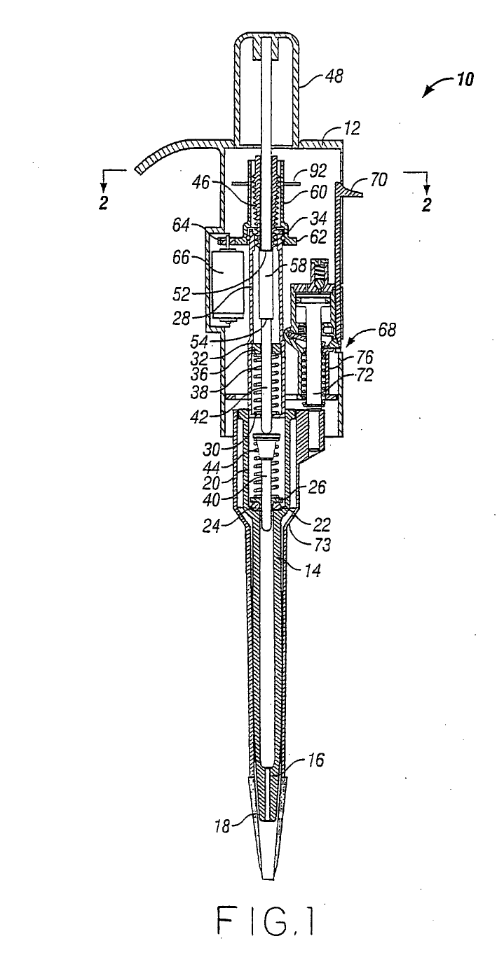

A pipette in accordance with an embodiment of the present invention is generally indicated at 10 in FIG. 1. The pipette includes a housing 12 with an axially projecting cylinder 14. Cylinder 14 has a tapered distal end defining a pipette tip holder 16. A pipette tip 18 is removably secured by friction to the tip holder 16. The opposite end of the cylinder has an enlarged head 20 with an internal ledge 22 on which is seated an O-ring 24 supporting an apertured seal 26. A sleeve 28 has an apertured lower end 30 received in the cylinder head 20. The sleeve 28 has an intermediate interior shoulder 32 and an internally threaded open upper end 34. A front stop collar 36 is biased upwardly against the internal shoulder 32 by a spring 38.

A piston 40 in the cylinder head 20 projects downwardly through the seal 26. The piston is biased upwardly against the lower end of a plunger 42 by a main spring 44. Plunger 42 extends upwardly through the apertured lower end 30 of sleeve 28, and through the front stop collar 36 and a tubular externally threaded screw 46, with its upper end projecting from the top of the housing 12 and into an axially depressable cap 48.

An enlarged intermediate section 58 of the plunger 42 defines upper and lower shoulders 52 and 54. Shoulder 52 is biased against the lower end of the screw 46 by the force of the main spring 44 acting on the piston 40. The lower screw end thus serves as a rear stop.

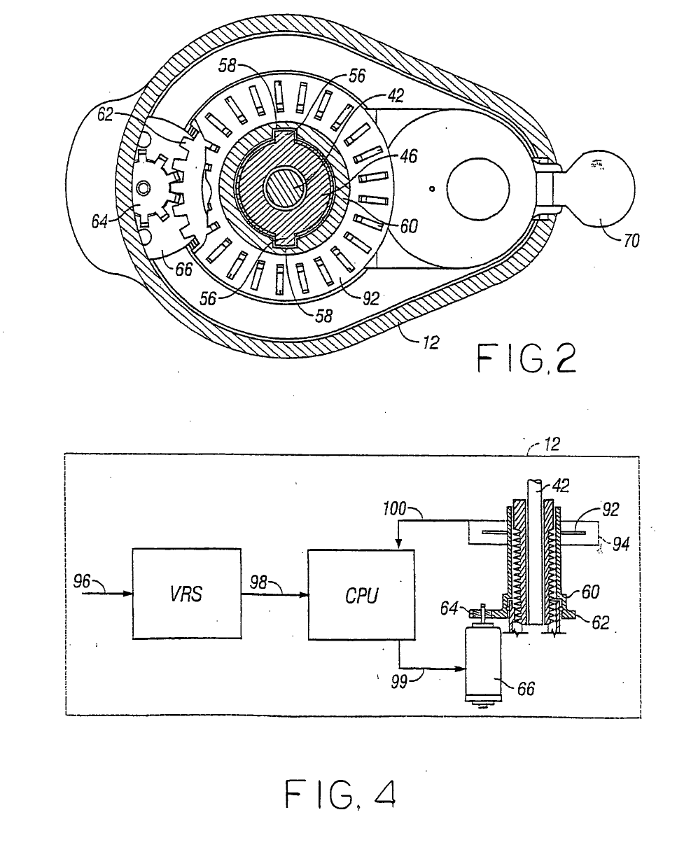

As can best be seen by additional reference to FIG. 2, the upper end of the screw 46 is provided with external ribs 56 slidably received in internal grooves 58 in a rotatable drive collar 60. An external gear 62 on the drive collar 60 meshes with a drive pinion 64 on the output shaft of a motor 66.

Actuation of motor 66 will cause the drive collar 60 to rotate, and the mechanical interengagement of the ribs 56 and grooves 58 will result in a corresponding rotation being imparted to the screw 46. The threaded engagement of the screw 46 with the upper end 34 of the fixed sleeve 28 will result in the screw being shifted axially to a desired setting of its lower end, which provides a rear stop for the plunger 42 and the piston 40 biased against its lower end by the main spring 44.

The setting of the rear stop will limit the extent to which the piston 40 can be retracted from the tubular portion of the cylinder 14, which in turn will control the volume of liquid that can be drawn into the pipettor tip 18 during aspiration.

Aspirated liquid is dispensed from the pipette tip by manually depressing the cap 48 to advance the plunger 42 and the piston 40 against the biasing force of the main spring 44. The plunger will continue to advance until the lower shoulder 54 of its enlarged intermediate section 58 engages the front stop 36, creating a first point of resistance which indicates that most of the aspirated liquid has been dispensed. By manually applying additional force to the plunger 42 in order to overcome the resistance of spring 38, the piston will be advance further to insure that any residual liquid will be “blown out” of the pipette tip 18.

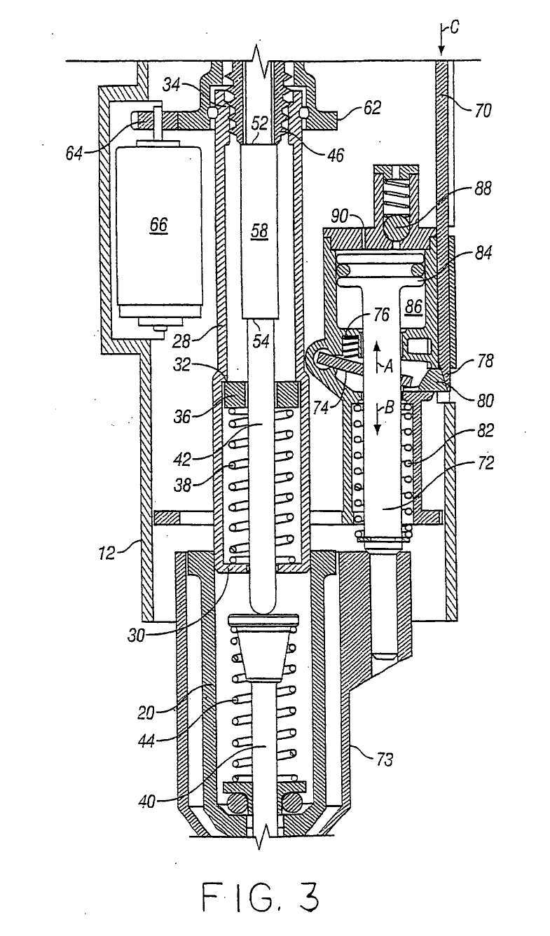

In another aspect of the invention, the pipette includes a tip ejector assembly generally indicated at 68 for removing a pipette tip 18 from the pipette tip holder 16. As can best be seen by a combined reference to FIGS. 1 and 3, the tip ejector assembly 68 includes a tip ejector actuator 70, a tip ejector shaft 72, a tip ejector sleeve 73 movable with the tip ejector shaft, and a lock collar 74. The lock collar allows one way movement of the tip ejector shaft 72 and sleeve 73 in the direction of arrow A in FIG. 3, but does not allow movement of these components in the opposite direction, the direction of arrow B, when the lock collar is oriented in its locking position, as illustrated. Therefore, when a disposable tip 18 is wedged upwardly onto the tip holder 16, the tip ejector sleeve 73 is pushed upwardly in the direction of arrow A. At the same time, the tip ejector shaft 72 will also move up a distance equal to the distance traveled by the tip ejector sleeve due to the fixed connection therebetween. The lock collar 74 will allow movement of the tip ejector shaft 72 in the direction of arrow A without resisting movement. However, the tip ejector shaft 72 will be prevented from moving in direction B toward the disposable tip 18 by the locking action of the lock collar 74.

A spring 76 is positioned to bias the lock collar into an angled, or locking position. The spring 76 keeps the tip ejector shaft 72 locked by the lock collar 74, and thus prevents the tip ejector shaft and the ejector sleeve 73 from moving in the direction of arrow B to dislodge and eject the pipette tip 18.

Depressing the tip ejector actuator 70 in the direction of arrow C will cause its tapered lower end 78 to coact with a mating inclined surface of a ramp wedge 80, causing the ramp wedge to shift in the direction of the lock collar, and creating a force lifting the lock collar from its angled locked position to a raised unlocked position. Once the lock collar is unlocked, the tip ejector shaft is released to move through the lock collar in the direction of arrow B under the force of spring 82. The tip ejector sleeve 73 will be correspondingly moved, causing the pipette tip 18 to be dislodged and ejected from the end of the pipette tip holder 16.

In another embodiment of the invention, a damper mechanism includes a piston 84 formed at the upper end of the tip ejector shaft 72. The piston is encircled by an O-ring seal and enclosed in a chamber 86 vented to atmosphere by a one way check valve 88. Movement of the tip ejector shaft in direction A causes air to be expelled from the chamber 86 via the check valve, whereas movement in direction B is retarded by the rate at which air can be readmitted to the chamber via a smaller bleed hole 90. The retarded rate of travel in direction B beneficially retards the velocity at which the pipette tip is ejected.

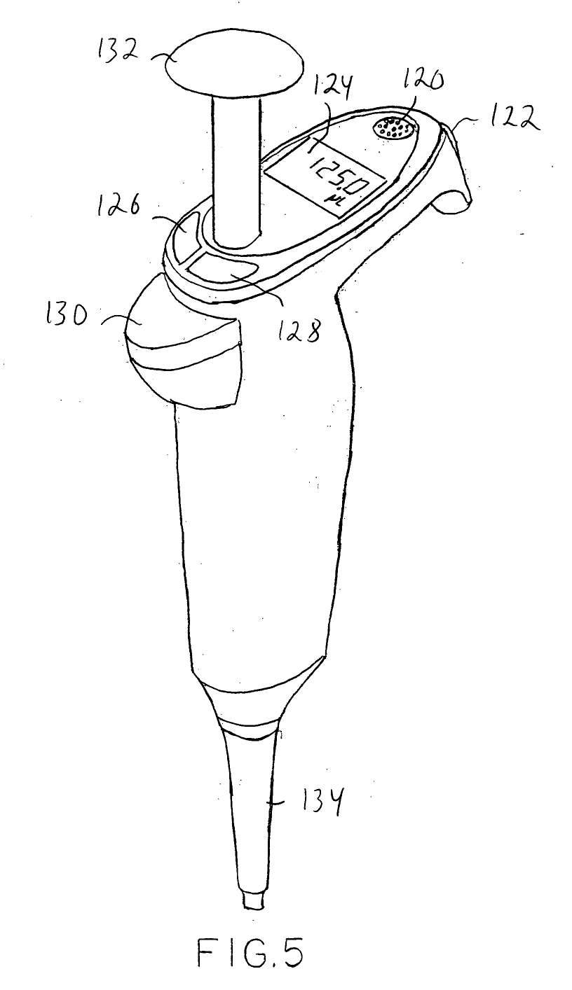

In another embodiment of the invention, as can be seen by reference to FIGS. 2 and 4, the adjustment drive collar 60 is surrounded by an encoder wheel 92 that rotates with the adjustment drive collar and that comprises part of an encoder assembly 94. The pipette includes a voice recognition system (VRS) that translates verbal commands 96 for volume settings and outputs the result 98 to a central processing unit (CPU). The CPU generates an electronic signal 99 that controls the motor 66, and may optionally receive input 100 from the encoder assembly 94 indicative of the position of the adjustable stop. The pipette's adjustment mechanism is thus moved automatically to the position corresponding to the voice input setting.

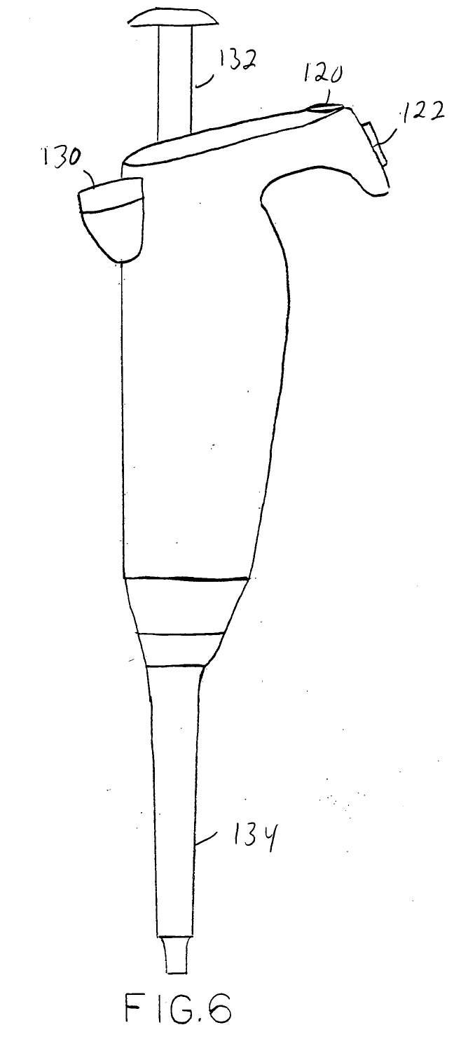

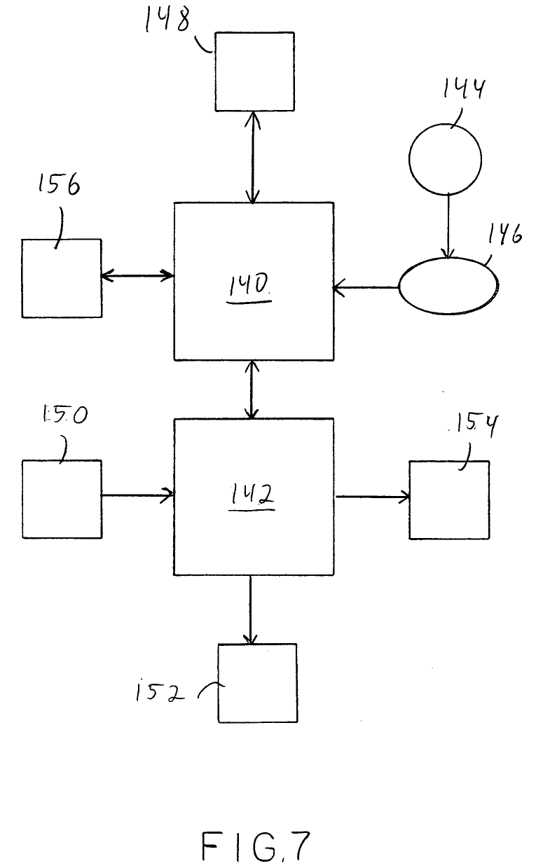

In accordance with further embodiments, the voice recognition system may provide a variety of features that further facilitate the efficiency and ease of use of the pipette. As shown in FIGS. 5 and 6, a pipette in accordance with another embodiment of the invention may include a microphone 120, a talk button 122, a display 124, a down button 126, an up button 128, a tip ejector button 130, a plunger 132 and a pipette tip 134. The voice recognition system may be employed using either speaker independent mode or speaker dependent mode. The speaker independent pipette may be pre-programmed to understand the digits in U.S. English. To use the pipette's speaker dependent capability, the user must say the digits during a training sequence that must be performed prior to using the voice recognition system. The pipette digitizes and records the spoken digit samples and uses them during voice recognition operation. Speaker dependent operation works for all languages.

The pipette's voice recognition system in speaker independent mode may operate in discreet mode, as opposed to continuous mode. In discreet mode, the user says a single digit, the pipette recognizes that digit and displays it on the screen, which prompts the user to say the next digits individually until all of the digits are recognized. In continuous mode, the user states all of the digits in a normal, fluid speech pattern, and they are all recognized at the same time.

The pipette recognizes the term “point” and uses the word to reduce the number of digits that need to be spoken for certain volume settings. For example, the four digit positions of a pipette with a maximum volume of 2.5 micro-liters are X.XXX and with the use of the term point, a user can simply say “two point” for the pipette to understand 2.000 micro-liters. This approach also increases the recognition accuracy of the pipette. Recognition accuracy is improved because the pipette's software uses knowledge of the expected decimal location in its algorithm.

The pipette's software also takes advantage of the fact that there are fewer than 10 digit options in the first position. The pipettes have maximum volumes of 5000 μL, 1000 μL, 200 μL, 100 μL, 20 μL, 10 μL and 2.5 μL. The LCD display 124 for any of these pipettes has four digit positions. For example, the 100 μL pipette displays 100.0 at its maximum volume. The voice recognition system only looks for either a one or a zero in the first position. This improves recognition rates and speed. Also, when the voice recognition system recognizes a “one” in the first position, then the only other digits it should recognize are zeros, also improving recognition rates. The only possible digits in the first position are zero through five for the 5000 μL, zero through two for the 2.5 μl, 20 μl and 200 μl pipettors, and zero and one for 10 μl, 100 μl and 1000 μl pipettes.

When the speaker dependent operation is selected, users are able to limit the use of their pipette by others by virtue of the fact that different people have sufficiently different intonations in their speech that the system may discern that the current use is not the authorized user. The pipette's speaker dependent voice recognition system, therefore, may work effectively only for the person who trained it. The pipette may also use voice recognition to “unlock” the pipette through a spoken keyword known to the original user, and spoken in the user's voice. For example, the owner of the pipette might choose to use her name as a spoken key to unlock the electronic features of the pipette. This keyword is recorded during the training session. Another potential user is not able to unlock the pipette even if they know the keyword, as the voice recognition system is looking for more than a simple word match.

The pipette's speaker dependent voice recognition system may also be programmed to work for multiple users. Each user trains the pipette separately in his or her language of choice. Each user also selects and records a keyword, which indicates to the pipette which digit data set to use for voice recognition. To use the pipette's voice recognition feature, the user simply states the keyword at the beginning of the session. Buttons or switches may also be provided for selecting which digit data set should be accessed by the voice recognition system.

The pipette has a secondary volume adjustment interface system. The interface includes down and up buttons 126 and 128 that will scroll the volume that is displayed and dispensed. It is intended for users who don't want to use the voice recognition system or for whom the voice recognition system does not work well.

The pipette has an internal beeper that sounds when the voice recognition system has recognized value that is out of the operating range of the pipette. While it is relatively easy to limit the range of the scrolling function of the secondary volume adjustment interface system, the user may speak an out of range value. The pipette has been designed to operate within a specific range, and therefore cannot accept volume values outside of that range. The out-of-range indication signals clearly that an improper value has been recognized.

Users of the pipette may adjust its volume rapidly and while using only the hand that is holding the pipette, and with minimum manipulation. The controls on the pipette are designed for users to be able to change the volume by simply pressing the talk button 122, saying the volume near the speaker 120, and releasing the talk button 122.

When changing the volume by using the voice recognition system, the pipette clears the screen 124 of previously entered digits when the “talk” button 122 is pressed. New digits are scrolled from the right-most position to left as they are recognized. For example, the first digit that is spoken is displayed in position 4 (where XXXX represents positions 1-4 from left to right). When the next digit is spoken and recognized, the first digit moves to position 3, and the new digit is placed into position 4. When the next digit is spoken and recognized, it is entered into next position. Leading zeros must be stated. This is repeated until the new volume has been entered. Fewer than four digits may be spoken for volumes that have insignificant leading zeros, such as when entering 2 μl into a 20 μl pipette (02.00).

The design of the “talk” button 122 and its position with respect to the display 124 serve to avoid accidental voice recognition circuitry activation. Accidental activation could cause the pipette to change to an unintended volume. Further, the pipette's software ignores momentary “talk” button strikes, which are assumed to be accidental. The software does this by delaying voice recognition circuitry activation for a short period. The purpose is to avoid accidental voice recognition listening that could cause the pipette to change to an unintended volume.

The pipette's microphone 120 is mounted in a position that makes it most effective for accurate voice recognition while the user is holding the pipette in a way that permits the display to be easily viewed. This permits the display 124 to be seen while the numbers are being recognized. The pipette's microphone 120 is mounted inside the housing of the pipette. There is a hole in the housing that allows the microphone to hear distortion free speech. To keep liquids and other contaminants from entering the housing, a barrier of thin film may be placed over the opening. The design of the barrier and selection of materials minimizes its effect on the incoming sound waves. The pipette's microphone 120 is mounted in rubber to minimize noises (vibration) from being transmitted through the pipette to the microphone. For example, sliding movement of the operator's fingers on the pipette housing could cause a background noise that negatively impacts the voice recognition system's performance.

The pipette's software includes a training sequence required for speaker dependent operation. The following illustrates a training method for a pipette in accordance with an embodiment of the invention. The first time the pipette is used, the operator enters a training mode via a setup menu. With instruction from the included manual, or from the LCD display, the user is directed to speak the numbers that are displayed. The display then shows a 1. The user says “one”, and the system then records the voice sound signal and stores this signal in memory. The pipette beeps to indicate successful recording. The display shows a 2 and similarly records the voice sound signal for the 2. The process is then repeated for the numbers 3-9 and 0. The entire process (for all numbers) is then repeated at least once for consistency so the voice recognition system may take an average of the sound it heard for each particular digit. It also allows the software to remove any background noise. The voice data is processed, saved and assigned to the appropriate digits. The user then exits the training to a normal operating mode, and is ready to use the voice recognition system to set the volume.

The pipette's beeper signals various events to the user. A single beep is used, for example, to indicate recognition of one of the digits, or completion of the volume change. A triple beep is generally used to indicate a problem, such as an actuator jam, out of range data entry, low battery, and other fault conditions. The beeper also clicks when a button is pressed, to avoid accidental activation and indicate that the button press has been registered by the circuitry.

The pipette is designed for ambidextrous talk button operation. The talk button 122 is on the centerline of the pipette and easily accessed by using either hand in one-handed operation. The circuitry for the pipette is all included within the pipette.

As shown in FIG. 7, the functional elements of the voice recognition and control system include a voice recognition processor 140, a main processor 142, a microphone 144, a coder/decoder (codec) 146, a English language library 148. a keypad 150, a display 152, and a linear actuator 154. For speaker independent operation, the English language library 148 stores the digital word profiles for all of the words the pipette must recognize. The words include the digits one through nine, zero and “oh”, and “point”. The English language library 1428 for the present embodiment may be, for example, provided by Sensory, Inc. of Santa Clara, Calif.

In certain embodiments, the system may also include a user's recorded library 156 that contains voice data that the user has recorded prior to using the voice recognition function of the pipette. The user must go through a training process in which his voice is recorded several times for each number the pipette is to recognize. This library 156 is used for speaker dependent operation. Speaker dependent operation is language independent, meaning that the user can speak any language in the recording session, and the pipette will be able recognize numbers in that language, by that operator.

The voice recognition processor 140 compares the digital signal coming from the codec 146 to the digital word profiles located in the language library. The codec 146 converts the analog signal from the microphone to a digital signal that the processor can understand.

The microphone 144 converts sound into a current and/or voltage signal that fluctuates as the sound varies in intensity and frequency. This analog output sent to the codec 146 for conversion to a digital signal. The main processor 142 handles several functions including the following. The main processor 142 processes signals from the keypad 150 and sends control signals to the linear actuator 154 for adjusting the pipetted volume. The main processor 142 receives signals from the encoder that confirms the position of the linear actuator. The main processor 142 controls the display 152 and turns the voice recognition processor 140 on. The main processor 142 processes and responds to the signal output by the voice recognition processor 140. The main processor 142 converts the user's desired volume to a calibrated stroke length that yields the most accurate pipetted volume. The main processor 142 also detects a low battery condition and detects error conditions, such as a jammed linear actuator.

The keypad 150 may be any of a wide variety of possible user input methods that require manual manipulation and interface with the electronic system on the pipette. The following keys, for example, may be included: A two button method for manually scrolling the volume up or down (visualized through the display); and a talk button that signals the main processor to turn the voice recognition system on. These three buttons will also be used to access and manipulate certain menu functions, such as calibration, voice recognition operation mode, and voice recognition training. The display 152 shows the user the selected volume. It also indicates other pipettor status information, such as low battery, or the existence of an error condition.

During operation of the voice recognition system, the user presses the talk button on the keypad. The main processor detects this event and turns the voice recognition circuitry on. The user then speaks the first digit of the desired pipette volume. The microphone's diaphragm vibrates in response to the speech, and this vibration is converted to a unique analog electrical signal. The codec then receives the analog signal from the microphone and converts it to a digital signal. The voice recognition processor receives the digital signal from the codec and compares it to the digital word profiles contained in memory in the English language library for speaker independent operation, or to the digital word profiles in the user's recorded library for speaker dependent operation. The user previously selected the operational mode (either speaker dependent or speaker independent U.S. English) for the pipette, and the processor only considers profiles in the library for the selected mode. The voice recognition processor selects the best match between the incoming signal and the digits contained in the library, and sends the result to the main processor. The main processor then changes the display to indicate the first digit output from the voice recognition processor. The user then says the next digit and the above process of speaking through changing the display is repeated until four digits have been recognized.

After four digits have been recognized and the user releases the talk button, and the main processor waits for a period (e.g., 0.5 seconds) before going on to the next step. This is to give the user an opportunity to re-enter the value and correct a mistake. The voice recognition circuit is turned off at this point. The main processor converts the desired volume to a linear actuator position that corresponds to that volume. This is normally done through a look-up table that ,may be developed experimentally. The main processor adjusts the pipette's mechanism to the new volume. The main processor monitors the signal from the encoder to detect errors and confirm movement of the stop. If the move is successful, then main processor goes into a sleep mode to conserve power. The selected volume remains displayed. The pipette is ready for use.

A pipette in accordance with another embodiment of the invention may speaker independent voice recognition for a wide variety of languages and accents, such as English, U.K. English, Spanish, French, German, and Japanese. The speaker independent pipette is pre-programmed to understand the digits in all of each language. This pipette's voice recognition system operates in continuous mode, as opposed to discreet mode. In continuous mode, the user states all of the digits in a normal, fluid speech pattern, and they are all recognized at the same time.

The pipette of the present embodiment recognizes the term “point” and may use this word to reduce the number of digits that need to be spoken for certain volume settings as discussed above with reference to the previous embodiment, and may also take advantage of the fact that there are may be a limited number of volumes available as also discussed above.

The present pipette system also includes a language library 156 that stores the digital word profiles for all of the words that the pipette must recognize, in all supported languages. The words include the digits one through nine, zero and “oh”, and “point” for the English language. The language library may also be provided by Sensory, Inc. of Santa Clara, Calif.

The remaining elements of the system are as discussed above with reference to the speaker dependent pipette. During the continuous mode, however, the voice recognition system functions as follows. The user presses the “talk” button on the keypad. The main processor detects this event and turns the voice recognition circuitry on. The user then speaks the desired volume. The microphone's diaphragm vibrates in response to the speech. This vibration is converted to a unique analog electrical signal. The codec receives the analog signal from the microphone and converts it to a digital signal. The voice recognition processor receives the digital signal from the codec and compares it to the digital word profiles contained in memory in the language library. The user previously selected the language of choice for the pipette, and the processor only considers profiles for this language. The voice recognition processor selects the best match between the incoming signal and the library, and sends the results to the main processor. The main processor then changes the display to indicate the output from the voice recognition processor. After four digits have been recognized and the user has released the talk button, the main processor 142 waits for a period (e.g., 0.5 seconds) before going on to the next step. This is to give the user an opportunity to re-enter the value and correct a mistake. The voice recognition circuit is turned off at this point. The main processor 142 converts the desired volume to a linear actuator position that corresponds to that volume. This is normally done through a look-up table, which is developed experimentally. The main processor 142 adjusts the pipette's mechanism to the new volume. The main processor 142 monitors the signal from the encoder to detect errors and confirm movement of the stop. If the move is successful, then main processor goes into a sleep mode to conserve power. The selected volume remains displayed. The pipette is then ready for use.

In accordance with a further embodiment of the invention, the voice recognition system may be employed in a fully automatic pipette as follows. The pipette may recognize terms (such as “faster” and “slower”) that are used to control the aspiration and dispense speeds. If, for example, the pipette is set at the lowest of the five possible speeds, the user would press the “talk” button and say “faster” to increase the speed at which the pipette aspirates or dispenses. Each time the term is stated, the pipette increases the speed by one increment. The display indicates the present setting graphically. Aspirate and dispense speeds can be adjusted both during programming and operation.

The pipette may recognize the following terms used to control the aspirate and dispense speeds of the pipette: “slow”, “medium slow”, “medium”, “medium fast”, “fast”, with the term “slow” indicating the slowest speed level, and the term “fast” indicating the highest speed level. The user presses the talk button and states the speed at which the pipette should operate. The display indicates the setting that was recognized. Aspirate and dispense speeds can be adjusted both during programming and operation.

The pipette is also able to recognize the term “program” followed by a number. The pipette allows up to six programs that have up to 40 pipetting operations each. This term is used to indicate to the pipette which pre-programmed routine to use. It is also used at the beginning of the programming to relate a program number to a specific pipetting routine. To select a specific program using the voice recognition system, the user presses the “talk” button and, for example, states “program 4” to invoke the previously established program 4. The display indicates this selection. At this point, the user can either run or configure program 4.

The pipette is able to recognize the term “fill”. The term “fill” is used while programming the pipette to indicate that the following string of digits is being stated to set the aspiration volume of the pipette. In the course of programming, the user states “fill-one-zero-zero-zero” to indicate that the pipette should aspirate 1000 μl into the pipette at that step in the program.

The pipette is also able to recognize the term “dispense”. The term “dispense” is used while programming the pipette to indicate that the following string of digits is being stated to set the dispense volume of the pipette. During programming, the user states “dispense-zero-one-zero-four” to indicate that the pipette should dispense 104 μl from the previously aspirated volume.

The pipette is also able to recognize the term “mix”. The term “mix” is used while programming the pipette to indicate that the following string of digits is being stated to set the mixing volume of the pipette. In the course of programming, the user states “mix-one-zero-zero-zero” to indicate that the pipette should cycle (dispense/aspirate) 1000 μl into and out of the pipette at that step in the program.

The pipette is also able to recognize the term “purge”. The term “purge” is used while programming or while operating the pipette to indicate that the pipette should dispense all liquid remaining in the pipette. The terms “start programming” and “end programming” are recognized to initiate and terminate programming of the pipette.

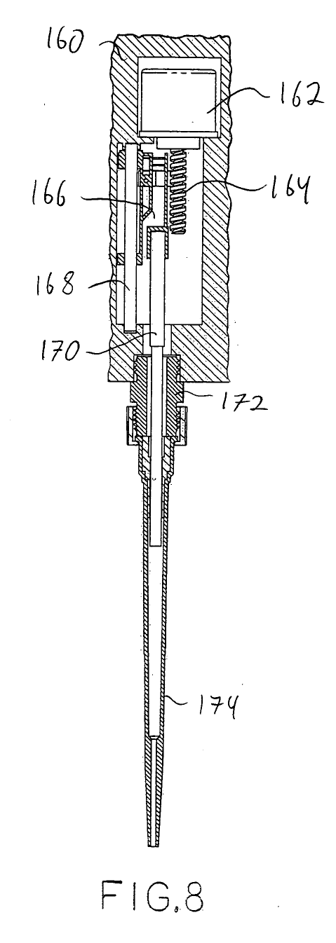

As shown in FIG. 8, a fully automatic pipette in accordance with an embodiment of the invention may include a housing 160, a motor 162, a motor screw shaft 164 that includes anti-backlash linkage, a follower 166, and a guide shaft 168. During use, the motor 162 drives the screw 164, which in turn drives the follower 166 along the guide shaft 168 to linearly actuate the a piston 170 responsive to signals from the voice recognition system. The linear movement of the piston 170 with respect to the coupling 172 causes fluid to be aspirated into or expelled from the pipette tip 174.

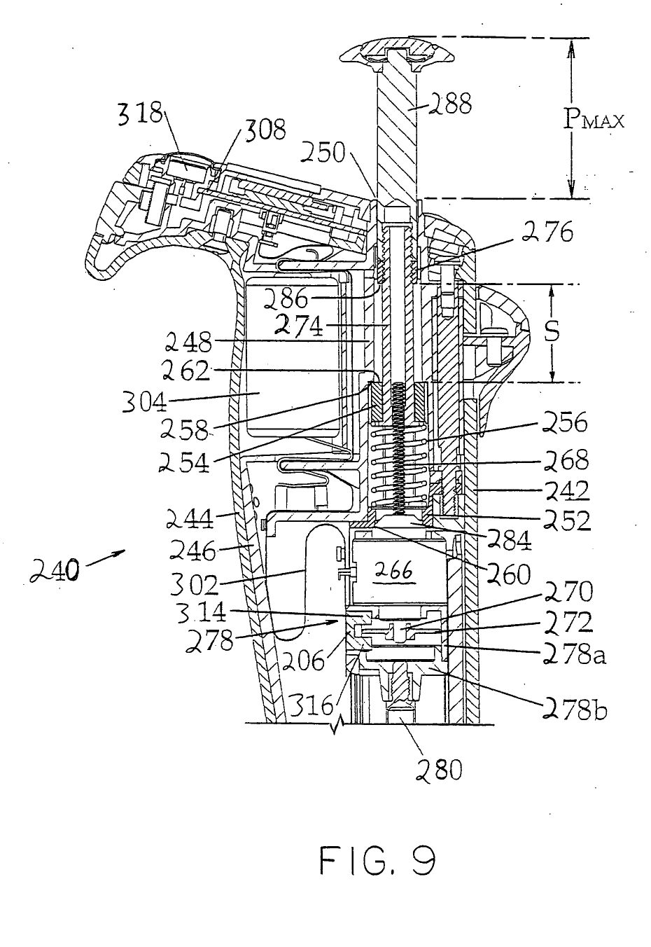

With reference to FIG. 9, a pipette 240 in accordance with another embodiment of the present invention may include an adjustable length piston. The pipette may be constructed and operate as disclosed in U.S. Ser. No. 10/855,690 filed May 27, 2004, the disclosure of which is hereby incorporated by reference. The pipette includes an outer housing 242 with a detachable cover 244. The housing 242 encloses an interior chassis 246 having a hollow guide 248 leading downwardly from an opening 250 in the top surface of the housing.

A fixed collar 252 is fitted into the bottom end of the hollow guide 248. A floating collar 254 is resiliently urged by a spring 256 against an interior ledge 258 on the hollow guide 248. A tapered interior shoulder on the collar 252 defines a first stop 260, and the upper rim of floating collar 254 defines a second stop 262. A chamber is aligned axially with the hollow chassis guide 248. The chamber projects downwardly from the lower end of the housing to a distal bottom end configured to releasably hold a detachable pipette tip.

An actuator assembly includes the following axially aligned components: a stepper drive motor 266 having an output shaft with a threaded upper end 268 and an oppositely extending bottom end 270 carrying an encoder wheel 272; a tubular sleeve 274 slidably extending through the floating collar 254 into the hollow guide 248, with its upper end externally threaded to receive a reference collar 276 and plunger 288, and its lower end internally threaded to receive the upper end 268 of the motor output shaft; an encoder housing 278 including an upper part 278a fixed to the underside of the motor 266, and a lower part 278b defining the bottom end of the actuator assembly. A piston 280 has its upper end engaged by the lower part 278b of the encoder housing, and its lower end projecting through a seal assembly into the upper end of lower chamber.

Although the piston 280 is shown engaged directly by the bottom end of the actuator assembly, it will be appreciated by those skilled in the art that other means may be provided for establishing a mechanical coupling between these two components. For example, an intermediate linkage might be employed, which would be of advantage in cases where the piston and actuator assembly are not aligned axially.

A tapered nose on motor 266 defines a first contact surface 284, and the lower rim of reference collar 276 defines a second contact surface 286. The actuator assembly may be viewed as being subdivided into a first section comprised of the motor 266 and encoder housing 278, and a second section comprised of the tubular sleeve 274, reference collar 276 and plunger 280, with the two sections being interconnected by the threaded upper end 268 of the motor output shaft.

At least one and preferably two parallel tension springs may extend between an anchor plate fixed to the motor 266, and external arms projecting laterally from an upper end of the hollow chassis guide 248. The springs serve to resiliently urge the actuator assembly into a “rest” position, at which the first contact surface 284 is in contact with the first stop 260, and the second contact surface 286 is spaced from the second stop 262 by a control distance “S”.

By manually depressing plunger 288, the actuator assembly can be axially shifted against the biasing force of springs from its rest position to a first advanced position, where the second contact surface 286 is in contact with the second stop 262, and the first contact surface 284 is spaced from the first stop 260. The control distance “S” between the second contact surface and the second stop thus defines the stroke of the actuator assembly between its rest and first advanced positions, which also defines the stroke of piston 280.

Fluid may be aspirated into the pipette tip by advancing the actuator assembly to its first advanced position, then submerging the pipette tip into the fluid, and then allowing the actuator assembly to return to its rest position. The thus aspirated fluid may then be dispensed by again advancing the actuator assembly to its first advanced position.

In order to ensure that all of the aspirated fluid has been dispensed, the piston assembly may be further advanced against the biasing action of both spring 256 and the two parallel tension springs to a second advanced or “blow out” position. This will result in the collar 254 being temporarily dislodged axially from the ledge 258 against which it is normally biased by spring 256.

The control distance “S” of the actuator assembly may be adjusted automatically by energizing the stepper motor 266 to rotate its output shaft 268 in the appropriate direction. Thus, the stepper motor may be operated to shorten the overall length of the actuator assembly by retracting the sleeve 274 through the collar 254, thus reducing the distance between the second contact surface 286 and the second stop 262, resulting in a shortened control distance. This adjustment can be made while the collar remains biased against the internal shoulder 258 on guide 248, and without any need to first unload any component from the biasing action of two parallel tension springs.

The sleeve 274 has radially outwardly projecting ribs engaged in internal grooves in the collar 254, and the collar in turn has external grooves receiving radially inwardly projecting ribs on the hollow chassis guide 248. This interlocking relationship prevents the sleeve 274 and collar 254 from rotating when the motor 266 is energized, without inhibiting relative axial shifting between the sleeve 274 and collar 254, and between the collar 254 and guide 248.

The encoder housing 278 has radially outwardly projecting ribs received in complimentary grooves in a lower portion of the chassis 246. This interlocked relationship stabilizes the motor 266 against rotation when it is energized to effect adjustments in the length of the actuator assembly.

The motor 266 is connected by a flexible connector 302 to a battery 304 that may be conveniently accessed by removing cover 244. The motor is controlled by a system with a feedback loop which includes the encoder wheel 272 carried by the lower end 270 of the motor output shaft. An optical sensor 306 is connected by connector 302 to a microprocessor on a PC board 308. The optical sensor includes a light source 314 and a photo cell 316 arranged respectively on opposite sides of the encoder wheel 272. Alternating teeth and slots on the encoder wheel are aligned between the two sensor elements 314, 316.

With this arrangement, the photocell 316 generates position signals responsive to the light and dark patterns generated by rotation of the encoder wheel 272. The position signals are fed back to the microprocessor. Preferably, the total number of teeth and slots equals the number of steps per revolution of the stepper motor 266, thus making it possible to recognize every step movement of the motor.

The stepper motor 266 may be operated in response to command signals input via a microphone 318 and processed by a voice recognition system embodied in the microprocessor as discussed above. The present embodiment makes it possible to effect piston stroke adjustments without first having to relieve the biasing forces being exerted by spring components. Axial alignment of the piston, operating plunger and stepper motor favors compactness, which in turn reduces costs and enhances the ease with which the pipette may be handled and operated by laboratory personnel. The feedback control system enables precise control and monitoring of stroke adjustments, with the ability to recognize errors and reset itself when necessary.

By shifting the upper section of the actuator assembly in relation to the lower section, with the latter being resiliently retained in the rest position with its first contact surface 284 in contact with the first stop 260, a further advantage is realized in that the magnitude of the resulting stroke can be visually assessed as a function of the extent to which the plunger 288 projects from the top of the housing. Thus, a maximum stroke will be referenced by a maximum plunger projection, as indicated at PMAX in FIG. 8.

In light of the foregoing, it will be understood by those skilled in the art that although the present invention has been described with reference to a pipette having a manually actuated piston, certain aspects of the invention including the motor driven stop adjustment mechanism, the voice recognition system, and the tip ejection mechanism, are also applicable to pipettes having motor driven pistons. Modifications and improvements within the scope of the present invention will become apparent to those skilled in the art. The above description is intended to be purely illustrative, and does not define the limits of the present invention:

What is claimed is:

1. A hand-held pipette comprising:
a pipette tip provided at one end of an elongated enclosure;
a piston received in an opposite end of said elongated enclosure; said piston being adapted for reciprocal movement within at least a portion of said elongated enclosure through a selected first stroke to aspirate a first volume of fluid into said pipette tip and to expel the thus aspirated first volume of fluid out of said pipette tip; and
voice recognition and control means for automatically adjusting the stroke of said piston from said first stroke to a second stroke responsive to voice commands such that a second volume of fluid may be aspirated into said pipette tip and the thus aspirated second volume of fluid may be expelled out of said pipette tip.

2. The hand-held pipette as claimed in claim 1, wherein said voice recognition and control means includes a motor.

3. The hand-held pipette as claimed in claim 2, wherein said motor is used to vary a distance between stop members.

4. The hand-held pipette as claimed in claim 2, wherein said piston includes an assembly of piston elements, and said motor is used to vary a length of said piston.

5. The hand-held pipette as claimed in claim 1, wherein said voice recognition and control means is user dependent.

6. The hand-held pipette as claimed in claim 1, wherein said voice recognition and control means is user independent.

7. The hand-held pipette as claimed in claim 1, wherein said pipette includes a memory of voice signals for various individual numbers.

8. The hand-held pipette as claimed in claim 1, wherein said pipette includes a memory of voice signals for a decimal point.

9. The hand-held pipette as claimed in claim 1, wherein said pipette includes a memory of a voice signal for a password.

10. The hand-held pipette as claimed in claim 1, wherein said pipette includes a memory of pre-programmed command words.

11. The hand-held pipette as claimed in claim 1, wherein said pipette includes a microphone that is located adjacent a display unit.

12. A hand-held pipette system comprising:
a pipette tip provided at one end of an elongated enclosure;
a piston received in an opposite end of said elongated enclosure; said piston being adapted for reciprocal movement within at least a portion of said elongated enclosure through a selected first stroke to aspirate a first volume of fluid into said pipette tip and to expel the thus aspirated first volume of fluid out of said pipette tip;
a voice recognition actuation switch that may be actuated by a user;
voice recognition means for providing a control signal responsive to a voice input signal received while said voice actuation switch is activated; and
control means for automatically adjusting the stroke of said piston from said first stroke to a second stroke responsive to control signal such that a second volume of fluid may be aspirated into said pipette tip and the thus aspirated second volume of fluid may be expelled out of said pipette tip.

13. The hand-held pipette system as claimed in claim 12, wherein said system includes a delay circuit that requires that the voice recognition switch is maintained in an activated state for a minimum period of time.

14. The hand-held pipette system as claimed in claim 12, wherein said voice recognition means is user dependent.

15. The hand-held pipette system as claimed in claim 12, wherein said voice recognition means is user independent.

16. A hand-held pipette comprising:
a pipette tip provided at one end of an elongated enclosure;
a piston received in an opposite end of said elongated enclosure; said piston being adapted for reciprocal movement within at least a portion of said elongated enclosure through a selected first stroke to aspirate a first volume of fluid into said pipette tip and to expel the thus aspirated first volume of fluid out of said pipette tip;
voice recognition means for providing a control signal responsive to a voice input signal, said voice recognition means including predictive means for matching a partial input string of numbers against a pre-defined group of possible settings, and for automatically entering the remaining numbers when only one possible setting exists for the partial input string; and
control means for automatically adjusting the stroke of said piston from said first stroke to a second stroke responsive to control signal such that a second volume of fluid may be aspirated into said pipette tip and the thus aspirated second volume of fluid may be expelled out of said pipette tip.

17. The hand-held pipette as claimed in claim 16, wherein said voice recognition means is user dependent.

18. The hand-held pipette as claimed in claim 16, wherein said voice recognition means is user independent.

19. A hand-held pipette comprising:
a pipette tip provided at one end of an elongated enclosure;
a piston received in an opposite end of said elongated enclosure; said piston being adapted for reciprocal movement within at least a portion of said elongated enclosure through a selected stroke to aspirate a first volume of fluid into said pipette tip and to expel the thus aspirated first volume of fluid out of said pipette tip;
voice recognition means for providing an actuation signal responsive to a voice input signal; and
actuation means for automatically moving said piston within the at least a portion of said elongated enclosure through the selected stroke to aspirate the first volume of fluid into said pipette tip responsive to said actuation signal.

20. The hand-held pipette as claimed in claim 19, wherein said voice recognition means further provides an actuation speed signal responsive to a speed voice input signal.

21. The hand-held pipette as claimed in claim 20, wherein said actuation means is further responsive to said actuation speed signal.

22. The hand-held pipette as claimed in claim 21, wherein said speed voice input signal incrementally causes the speed of actuation of said piston to be changed incrementally.

23. A hand-held pipette comprising:
a pipette tip provided at one end of an elongated enclosure;
a piston received in an opposite end of said elongated enclosure; said piston being adapted for reciprocal movement within at least a portion of said elongated enclosure through a selected stroke to aspirate a first volume of fluid into said pipette tip and to expel the thus aspirated first volume of fluid out of said pipette tip;
voice recognition means for providing a control signal responsive to a voice input signal; and
actuation means for automatically moving said piston within the at least a portion of said elongated enclosure through the selected stroke to expel the thus aspirated volume of fluid out of said pipette tip responsive to said actuation signal.

24. The hand-held pipette as claimed in claim 23, wherein said voice recognition means further provides an actuation speed signal responsive to a speed voice input signal.

25. The hand-held pipette as claimed in claim 24, wherein said actuation means is further responsive to said actuation speed signal.

26. The hand-held pipette as claimed in claim 25, wherein said speed voice input signal incrementally causes the speed of actuation of said piston to be changed incrementally.
